(19) United States
(12) Patent Application Publication
(10) Pub. No.: US 2004/0164671 A1
(43) Pub. Date: Aug. 26, 2004

(54) Organic light emitting diode

(75) Inventor: Takafumi Noguchi, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/784,966

(22) Filed: Feb. 25, 2004

(30) Foreign Application Priority Data
Feb. 25, 2003 (JP) P.2003-047544

(51) Int. Cl. H05B 33/00

(52) U.S. Cl. 313/504

(57) ABSTRACT

An organic light emitting diode comprising: a substrate; a transparent electrode; at least two organic layers including a light emitting layer and an electron transporting layer: and a back electrode, wherein a thickness of the electron transporting layer is 60 nm or greater, and a total thickness of the electron transporting layer and the light emitting layer is 90 nm or smaller.

### FIELD OF THE INVENTION

This invention relates to an organic light emitting diode (hereinafter abbreviated as “OLED”) (an organic electroluminescent device) useful as a planar light source, such as a backlight unit of full color displays or an illumination light source, or a light source array of printers. The OLED of the invention features improved light extraction efficiency.

### BACKGROUND OF THE INVENTION

OLEDs generally have at least one organic layer including a light emitting layer sandwiched in between a pair of opposing electrodes. With an electric field applied to the electrodes, electrons and positive holes are injected from the cathode and the anode, respectively, into the light emitting layer, where they are recombined to emit light as an energy difference between the conduction and valence bands. The organic layers are generally three layers stacked in the order of hole transporting layer/light emitting layer/electron transporting layer. A single organic layer structure, i.e., a light emitting layer alone, and a two organic layer structure composed of a hole transporting (injecting) layer and an electron-transporting light-emitting layer are also known.

Although OLEDs have excellent characteristics such as thinness, lightness, short response time, wide viewing angle, and low power consumption, they often involve an interference phenomenon inside the diode due to overall reflection of emitted light on the interface because, for one thing, the organic layers including a light emitting layer are very thin and, for another, the organic layers have high refractive indices. Light is therefore apt to be confined inside the diode, resulting in a low light extraction efficiency. An organic layer such as a light emitting layer usually has a thickness of 10 to 200 nm and a refractive index of 1.6 to 2.1. Under these conditions the light extraction efficiency of the diode is less than 20%. To control light confinement due to interference thereby to increase light extraction efficiency is indispensable for improving luminescence efficiency and luminance of OLEDs.

In order to control light confinement due to interference, it is essential to optimize layer thickness. For this purpose, it has been proposed to adjust the thickness of an electron transporting layer to (2N−1)λ/4n (see JP-A-2002-289358) or the total thickness of an electron transporting layer and a light emitting layer within a range λ/8n to 3λ/8n (see JP-A-2002-299062).

### SUMMARY OF THE INVENTION

OLEDs are promising for application to displays, illumination, backlights, and the like. In these fields of application, OLEDs are indispensably required to emit white light. Known techniques for obtaining white light emission include use of a luminescent material capable of emitting white light and use of a plurality of luminescent materials different in luminescence waveform (luminescence wavelength) either stacked in the thickness direction or laid side-by-side in the same plane. However, a white light emitting material suitable for practical use has not been synthesized as yet. Driving a stack of luminescent materials needs a multi-layer TFT, which is very difficult to manufacture with the state-of-the-art technology.

For the time being, it would be practical to use luminescent materials different in luminescence waveform in the same plane. Nevertheless, the above-described related art techniques cannot get rid of the problem that luminescence efficiency and degree of whiteness conflict to each other because the optimum layer thickness depends on luminescence waveform. For example, a diode having two or more luminescent materials in a side-by-side configuration with equal thickness requires an increased voltage in some sites of light emission.

In the light of the above circumstance, the object of the present invention is to provide an OLED with an optimized layer thickness and improved light extraction efficiency. In particular, it is an object of the invention to provide a multi-color OLED having a plurality of luminescent materials different in luminescence waveform in a side-by-side configuration which emits white light at a high efficiency and in a stable manner.

The above object of the invention is accomplished by an OLED comprising a substrate, a transparent electrode, at least two organic layers including a light emitting layer and an electron transporting layer, and a back electrode, in which the thickness of the electron transporting layer is 60 nm or greater, and the total thickness of the electron transporting layer and the light emitting layer is 90 nm or smaller.

The invention provides preferred embodiments of the OLED, in which:

the transparent electrode has a thickness of 50 to 210 nm;

the organic layers have a total thickness of 90 to 300 nm;

the sum of the thickness of the transparent electrode and the total thickness of the organic layers is 250 to 400 nm; and

the diode has at least two light emitting layers different in luminescence waveform in a side-by-side configuration.

### BRIEF DESCRIPTION OF THE DRAWINGS

FIG. 1 is a schematic cross-section showing a typical layer structure of an OLED according to the present invention.

FIG. 2 (FIGS. 2A, 2B, 2C and 2D) represents a flow chart for making a finely patterned organic layer.

FIG. 3 shows a pattern of a light emitting layer (pixels) of the multi-color OLEDs prepared in working Examples.

### DETAILED DESCRIPTION OF THE INVENTION

The OLED of the present invention has a laminate structure having a transparent electrode, organic layers including at least a light emitting layer and an electron transporting layer, and a back electrode stacked on a substrate.

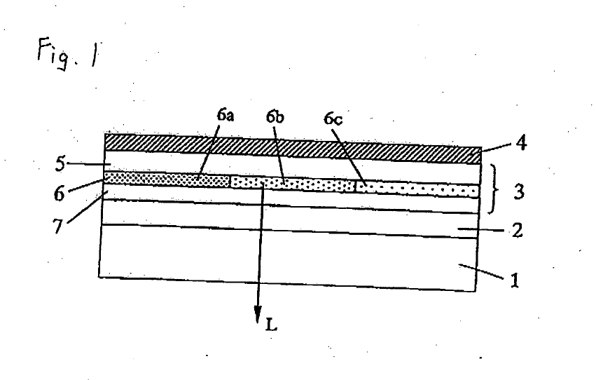

An example of the OLED according to the invention is schematically illustrated in FIG. 1. The OLED of FIG. 1 has a laminate structure in which a transparent electrode 2, organic layers 3 (i.e., an electron transporting layer 5, a light emitting layer 6, and a hole transporting layer 7), and a back electrode 4 are stacked on a substrate 1 in the order described. The positional relationship of the two electrodes with respect to the substrate may be reverse from that shown in FIG. 1. That is, the substrate 1 can have formed thereon the back electrode 4, the organic layers 3, and the transparent electrode 2 in this order. Light L generated in the light emitting layer 6 is emitted from the side of the transparent electrode 2.

The light emitting layer 6 may be formed of a plurality of light emitting layers. In the example shown in FIG. 1, at least two light emitting layers 6a, 6b, and 6c having different luminescence waveforms are laid side by side in the same plane parallel to the substrate 1 to provide a multi-color OLED.

The set of organic layers 3 may have a hole injecting layer. An electron injecting layer may be provided between the set of organic layers and the electrode. Layer structures containing these organic layers include (i) transparent electrode/hole transporting layer/light emitting layer/electron transporting layer/back electrode, (ii) transparent electrode/light emitting layer/electron transporting layer/electron injecting layer/back electrode, and (iii) transparent electrode/hole injecting layer/hole transporting layer/light emitting layer/electron transporting layer/electron injecting layer/back electrode, each provided on the substrate in the order described or the reverse order.

In the present invention the thickness of each layer constituting the OLED is specified as follows. The thickness of the electron transporting layer 5 is 60 nm or greater. The total thickness of the electron transporting layer 5 and the light emitting layer 6 is 90 nm or smaller. An OLED satisfying these layer thickness conditions exhibits improved light extraction efficiency, which leads to improved luminescence efficiency. The thickness conditions being fulfilled, the light extraction efficiency for visible light (wavelength: about 380 to 780 nm) can be improved to an equal degree independently of wavelength. Accordingly, a multi-color OLED having two or more light emitting layers 6a, 6b, and 6c different in luminescence waveform is allowed to be designed to have a uniform thickness for all the light emitting layers within the recited range. With a uniform thickness, all the interfaces inside a diode can be made smooth, which not only facilitates fabrication of the diode but brings about improved durability of the diode, i.e., proved resistance against insulation breakdown.

For enhancing the improvement on luminescence efficiency, it is preferred for the electron transporting layer 5 to have a thickness of 70 to 80 nm, and for the electron transporting layer 5 and the light emitting layer 6 to have a total thickness of 80 to 90 nm. The thickness of the light emitting layer is decided so as to satisfy the recited thickness conditions. A preferred light emitting layer thickness is 10 to 20 nm.

The transparent electrode 2 preferably has a thickness of 50 to 210 nm, particularly 160 to 200 nm. The total thickness of the organic layers 3 is preferably 90 to 300 nm, still preferably 150 to 250 nm. In the invention, the term “total thickness of the organic layers” includes a thickness of an electron injecting layer, though the electron injection layer is not made by organic materials. The sum of thickness of the transparent electrode 2 and the organic layers 3 is preferably 250 to 400 nm, still preferably 300 to 350 nm.

Materials of the elements making up the OLED and the driving mode of the OLED will then be described in order.

(1) Organic Layers

The light emitting layer, electron transporting layer, hole transporting layer, and hole injecting layer are organic layers made of organic compounds. Examples of the organic compounds used to form each organic layer are described, e.g., in Monthly DISPLAY December issue 1998 (separate volume “Yuki EL Display”) by Techno Times Co., Ltd.

(a) Light Emitting Layer

The light emitting layer contains at least one luminescent compound. The luminescent compound may be a fluorescent compound, a phosphorescent compound or a combination thereof. A phosphorescent compound is preferred from the standpoint of luminance and luminescence efficiency.

Useful fluorescent compounds include benzoxazole derivatives, benzimidazole derivatives, benzothiazole derivatives, styrylbenzene derivatives, polyphenyl derivatives, diphenylbutadiene derivatives, tetraphenylbutadiene derivatives, naphthylimide derivatives, coumarin derivatives, perylene derivatives, perinone derivatives, oxadiazole derivatives, aldazine derivatives, pyrralidine derivatives, cyclopentadiene derivatives, bisstyrylanthracene derivatives, quinacridone derivatives, pyrrolopyridine derivatives, thiadiazolopyridine derivatives, styrylamine derivatives, aromatic dimethylidyne compounds; metal complexes typified by metal complexes or rare earth element complexes of 8-quinolinol derivatives; and polymers, such as polythiophene derivatives, polyphenylene derivatives, polyphenylene vinylene derivatives, and polyfluorene derivatives. These fluorescent compounds can be used either individually or as a mixture of two or more thereof.

The phosphorescent compounds preferably include, but are not limited to, ortho-metalated complexes and porphyrin metal complexes. Of porphyrin complexes are preferred porphyrin platinum complexes. The phosphorescent compounds can be used either individually or as a combination of two or more thereof.

“Ortho-metalated complex” is a generic term given to the compounds described, e.g., in Yamamoto Akio, Yukikinzokukagaku-kiso to ohyo, Shokabo Publishing Co., 1982, p150 and 232 and H. Yersin, Photochemistry and Photophysics of Coordination Compounds, Springer-Verlag, 1987, pp. 71-77 and 135-146.

The ligands which form the ortho-metalated complexes preferably include, but are not limited to, 2-phenylpyridine derivatives, 7,8-benzoquinoline derivatives, 2-(2-thienyl)pyridine derivatives, 2-(1-naphthyl)pyridine derivatives, and 2-phenylquinoline derivatives. These derivatives may have a substituent according to necessity. The ortho-metalated complexes can have other ligands in addition to the above-recited ones. Any transition metal can be used as a center metal of the ortho-metalated complexes. In this particular embodiment, rhodium, platinum, gold, iridium, ruthenium, and palladium are preferred.

The organic light emitting layer containing the ortho-metalated complex is advantageous in terms of luminance and luminescence efficiency. Specific examples of useful ortho-metalated complexes are described in Japanese Patent Application No. 2000-254171. The ortho-metalated complexes which can be used in the invention are synthesized according to various known techniques, such as those described in Inorg. Chem., 1991, 30, 1685, ibid., 1988, 27, 3464, ibid., 1994, 33, 545, Inorg. Chim. Acta, 1991, 181, 245, J. Organomet. Chem., 1987, 335, 293, and J. Am. Chem. Soc., 1985, 107, 1431.

The concentration of the luminescent compound in the light emitting layer is not particularly limited but is preferably 0.1 to 70% by weight, more preferably 1 to 20% by weight.

If desired, the light emitting layer can further contain a host material, a hole transporting material, an electron transporting material, an electrically inert binder resin, etc. Some compounds function two or more functions of these functional materials. For example, carbazole derivatives function as not only a host material but a hole transporting material.

The terminology “host material” as used herein means a compound which transfers energy from its excited state to a luminescent compound thereby causing the luminescent compound to emit light. Examples of such materials include carbazole derivatives, triazole derivatives, oxazole derivatives, oxadiazole derivatives, imidazole derivatives, polyarylalkane derivatives, pyrazoline derivatives, pyrazolone derivatives, phenylenediamine derivatives, arylamine derivatives, amino-substituted chalcone derivatives, styrylanthracene derivatives, fluorenone derivatives, hydrazone derivatives, stilbene derivatives, silazane derivatives, aromatic tertiary amine compounds, styrylamine compounds, aromatic dimethylidyne compounds, porphyrin compounds, anthraquinodimethane derivatives, anthrone derivatives, diphenylquinone derivatives, thiopyran dioxide derivatives, carbodiimide derivatives, fluorenylidenemethane derivatives, distyrylpyrazine derivatives, heterocyclic (e.g., naphthalene or perylene) tetracarboxylic acid anhydrides, phthalocyanine derivatives, metal complexes of 8-quinolinol derivatives, methallo-phthalocyanines, metal complexes having benzoxazole, benzothiazole, etc. as a ligand, polysilane compounds, poly (N-vinylcarbazole) derivatives, aniline copolymers, conductive polymers (e.g., thiophene oligomers and polythiophene), polythiophene derivatives, polyphenylene derivatives, polyphenylene vinylene derivatives, and polyfluorene derivatives. They can be used either individually or as a combination of two or more thereof.

The host material concentration in the light emitting layer is preferably 0 to 99.9% by weight, still preferably 0 to 99.0% by weight.

The hole-transporting materials which can be used in the invention are not limited, whether low-molecular or high-molecular, as long as any one of a function of injecting holes from the anode, a function of transporting the holes, and a function of blocking electrons injected from the cathode is performed. Examples of such materials include carbazole derivatives, triazole derivatives, oxazole derivatives, oxadiazole derivatives, imidazole derivatives, polyarylalkane derivatives, pyrazoline derivatives, pyrazolone derivatives, phenylenediamine derivatives, arylamine derivatives, amino-substituted chalcone derivatives, styrylanthracene derivatives, fluorenone derivatives, hydrazone derivatives, stilbene derivatives, silazane derivatives, aromatic tertiary amine compounds, styrylamine compounds, aromatic dimethylidyne compounds, porphyrin compounds, polysilane compounds, poly(N-vinylcarbazole) derivatives, aniline copolymers, conductive polymers (e.g., thiophene oligomers and polythiophene), polythiophene derivatives, polyphenylene derivatives, polyphenylene vinylene derivatives, and polyfluorene derivatives. They can be used either individually or as a combination of two or more thereof. A preferred content of the hole transporting material in the light emitting layer is 0 to 99.9% by weight, particularly 0 to 80.0% by weight.

The electron-transporting material which can be used in the invention are not limited as long as at least one of a function of injecting electrons from the cathode, a function of transporting electrons, and a function of blocking the holes injected from the anode is performed. Examples of electron-transporting materials include triazole derivatives, oxazole derivatives, oxadiazole derivatives, fluorenone derivatives, anthraquinodimethane derivatives, anthrone derivatives, diphenylquinone derivatives, thiopyran dioxide derivatives, carbodiimide derivatives, fluorenylidenemethane derivatives, distyrylpyrazine derivatives, heterocyclic (e.g., naphthalene or perylene) tetracarboxylic acid anhydrides, phthalocyanine derivatives, metal complexes of 8-quinoliol derivatives, metallo-phthalocyanines, metal complexes having benzoxazole or benzothiazole as a ligand, aniline copolymers, conductive polymers (e.g., thiophene oligomers and polythiophene), polythiophene derivatives, polyphenylene derivatives, polyphenylene vinylene derivatives, and polyfluorene derivatives. The compounds described in JP--A-2001-335776 are also useful. The light-emitting layer preferably contains the electron transporting material in an amount of 0 to 99.9% by weight, particularly 0 to 80.0% by weight.

Examples of binder resins useful for the light emitting layer are polyvinyl chloride, polycarbonate, polystyrene, polymethyl methacrylate, polybutyl methacrylate, polyester, polysulfone, polyphenylene oxide, polybutadiene, hydrocarbon resins, ketone resins, phenoxy resins, polyamide, ethyl cellulose, polyvinyl acetate, ABS resins, polyurethane, melamine resins, unsaturated polyester resins, alkyd resins, epoxy resins, silicone resins, polyvinyl butyral, and polyvinyl acetal. These binder resins can be used either individually or as a mixture thereof. Use of the binder resin is advantageous in that the light emitting layer can be formed easily and over a wide area by a wet film formation technique.

(b) Hole Transporting Layer

If necessary, the OLED may have a hole transporting layer containing the above-described hole transporting material in addition to the light emitting layer. The hole transporting layer may contain the above-described binder resin.

(c) Electron Transporting Layer

The OLED of the invention has an electron transporting layer containing the above-described electron transporting material. The electron transporting layer may contain the above-described binder resin.

The organic layers can be formed either by dry film formation, such as vacuum deposition, or wet film formation, such as dipping, spin coating, dip coating, casting, die coating, roll coating, bar coating, gravure coating. Wet film formation is advantageous in that organic layers can easily be formed over a wide area and that an OLED with high luminance and high luminescence efficiency can be produced efficiently and economically. A suitable film formation method is chosen according to the material of the layer. A layer formed by wet film formation can be dried. The drying conditions, while not particularly limited, should be selected so as not to damage the layer.

As previously stated, a binder resin can be incorporated into an organic layer where the layer is to be formed by wet film formation. Examples of useful binder resins which can be used in the organic layers are the same as those recited above with respect to the light-emitting layer. The binder resins can be used either individually or as a mixture thereof in each layer.

Where an organic layer is to be formed by wet film formation, a coating composition is prepared by dissolving the organic material in a solvent. The solvent to be used is not particularly limited and chosen appropriately according to the kinds of the constituents, i.e., the hole-transporting material, the ortho-metalated complex, the host material, the binder resin, and so forth. Examples of useful solvents are halogen-containing solvents, such as chloroform, carbon tetrachloride, dichloromethane, 1,2-dichloroethane, and chlorobenzene; ketones, such as acetone, methyl ethyl ketone, diethyl ketone, n-propyl methyl ketone, and cyclohexanone; aromatic solvents, such as benzene, toluene, and xylene; esters, such as ethyl acetate, n-propyl acetate, n-butyl acetate, methyl propionate, ethyl propionate, γ-butyrolactone, and diethyl carbonate; ethers, such as tetrahydrofuran and dioxane; amide solvents, such as dimethylforamide and dimethylacetamide; dimethyl sulfoxide; and water.

The ratio of the solvent to the solids content in the coating composition is not particularly limited. The density of the coating composition is also arbitrarily selected depending on the wet film formation process adopted.

Depending on use, for example, when the OLED is used as a light source of electron displays, the organic layers may be formed in stripes or a matrix pattern. In this case, a finely patterned organic layer can be formed (i) by using a mask having a pattern of fine openings or (ii) by a transfer method using a transfer material having an organic layer on a carrier film, which is superposed on a substrate (a layer on which an organic layer is to be formed) to patternwise transfer the organic layer to the substrate. The patternwise transfer of the organic layer is achieved by pressing the transfer material from its carrier side with a pressing member having projections and depressions in a prescribed pattern.

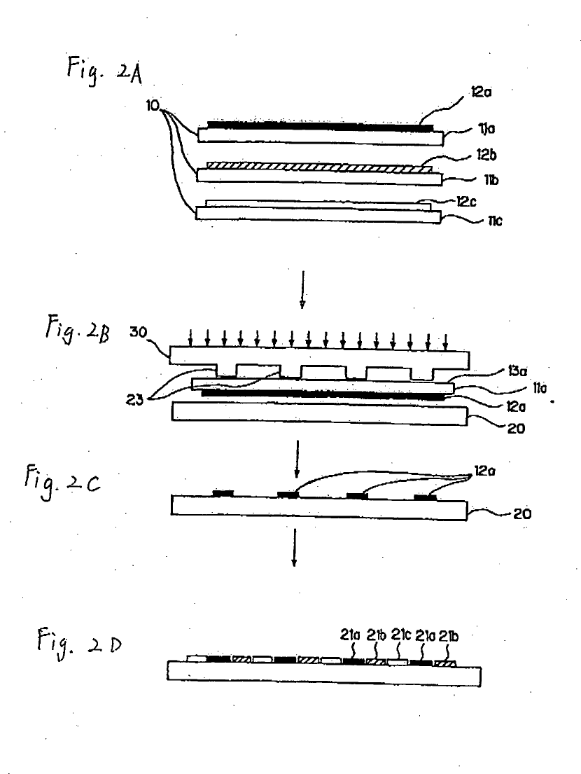

The steps for forming a finely patterned organic layer in accordance with the transfer method (ii) are shown in FIG. 2. To begin with, transfer materials 11a, 11b, and 11c having the respective organic layers 12a, 12b, and 12c formed on the respective carriers 10 are prepared (see FIG. 2A). One of the transfer materials, e.g., the transfer material 11a is superposed on a base 20 with the organic layer 12a in contact with the base 20. A pressing member 30 having projections 23 in a prescribed pattern on its surface is pressed to the carrier side 13a of the transfer material 11a opposite the organic layer 12a (see FIG. 2B), whereby the parts of the organic layer 12a that correspond to the projections 23 are transferred to the base 20 (see FIG. 2C). The same steps are repeated with the transfer materials 11b and 11c thereby to form a pattern of organic layers 21a, 21b, and 21c (see FIG. 2D). Coplanar organic layers with a desired spacing among themselves can be formed by changing the distance between the organic layers 21a, 21b, and 21c.

According to the transfer method, a multi-color OLED having organic layers different in luminance waveform in a side-by-side configuration can easily be produced using organic materials having different compositions corresponding to the organic layers 12a, 12b, and 12c. For the details of forming organic layers in a fine pattern, reference can be made in JP-B-2003-139944.

A plurality of coplanar organic layers can also be formed by dry film formation techniques, such as vacuum deposition and sputtering, wet film formation techniques, such as dipping, spin coating, dip coating, casting, die coating, roll coating, bar coating, and gravure coating, or printing.

(2) Substrate

Materials of the substrate include inorganic substances, such as yttrium-stabilized zirconia (YSZ) and glass; polymers, such as polyesters, e.g., polyethylene terephthalate, polybutylene terephthalate, and polyethylene naphthalate, polystyrene, polycarbonate, polyether sulfone, polyarylate, allyl diglycol carbonate, polyimide, polycycloolefins, norbornene resins, polychlorotrifluoroethylene, Teflon®, and tetrafluoroethylene-ethylene copolymers; foil of metal, e.g., aluminum, copper, stainless steel, gold or silver; and liquid crystal polymers.

Flexible substrates are of choice for resistance to breakage, ease of folding, and light weight. Recommended materials for flexible substrates include polyimide, polyester, polycarbonate, polyether sulfone, metal foil (e.g., aluminum, copper, stainless steel, gold or silver), liquid crystal polymers, and fluoropolymers (e.g., polychlorotrifluoroethylene, Teflon, tetrafluoroethylene-ethylene copolymers). They are excellent in heat resistance, dimensional stability, solvent resistance, electrical insulating properties, and processability and exhibit low air permeability and low hygroscopicity.

Metal foils having an insulating layer on one or both sides thereof are of choice for averting a short circuit of the diode. Useful metal foils are of aluminum, copper, stainless steel, gold, silver, etc. Aluminum foil and copper foil are preferred for their processability and low price. The electrically insulating layer is not particularly restricted in material and can be made of, for example, inorganic oxides, inorganic nitrides, or polymers, such as polyester (e.g., polyethylene terephthalate, polybutylene terephthalate, and polyethylene naphthalate), polystyrene, polycarbonate, polyether sulfone, polyarylate, allyl diglycol carbonate, polyimide, polycycloolefins, norbornene resins, polychlorotrifluoroethylene, and polyimide.

The shape, structure, and size of the substrate are not particularly limited and selected appropriately according to the intended use or purpose of the diode. In general, the substrate has a plate shape and may have either a single layer structure or a multilayer structure. It may be made of a single member or two or more members. The substrate may be either transparent or opaque. Where light is to be extracted from the substrate side, the substrate is preferably colorless transparent or colored transparent. A colorless transparent substrate is more preferred for suppressing light scattering and decay.

In order to prevent the electrodes or organic layers from separating from the substrate by the beat applied during preparation or use and thereby to improve durability, it is preferred for the substrate to have a coefficient of linear thermal expansion of 20 ppm/° C. or smaller. A coefficient of linear thermal expansion of a substrate is measured as a change in length of a sample being heated at a constant rate by, for most cases, thermomechanical analysis (TMA).

In using a metal foil laminated with an insulating layer as a substrate, it is preferred for the insulating layer also to have a coefficient of linear thermal expansion of 20 ppm/° C. or smaller. Materials providing an insulating layer with a linear thermal expansion coefficient of 20 ppm/° C. or smaller include metal oxides, such as silicon oxide, germanium oxide, zinc oxide, aluminum oxide, titanium oxide, and copper oxide, and metal nitrides, such as silicon nitride, germanium nitride, and aluminum nitride, and mixtures thereof. The metal oxide and/or metal nitride insulating layer preferably has a thickness of 10 to 1000 nm for maintaining insulating performance. The metal oxide and/or metal nitride insulating layer can be formed by dry film formation techniques such as vacuum deposition, sputtering and CVD, wet processes such as a sol-gel process, or by applying a dispersion of the metal oxide and/or metal nitride particles in a solvent to a metal foil.

Polyimide and liquid crystal polymers are preferably used to make a substrate having a linear thermal expansion coefficient of 20 ppm/° C. or smaller. Details of the properties of such polymer materials are described, e.g., in Plastic Data Book published by Plastic Editorial Department of Asahi Kasei Amidas Co., Ltd. Where polyamide is used as an insulating layer, it is preferably combined with an aluminum foil. The polyimide sheet preferably has a thickness of 10 to 200 μm for ease of handling.

The insulating layer can be provided on one or both sides of the metal foil. In the latter case, the two insulating layers may be made of a metal oxide and/or a metal nitride or a resin, such as polyimide; or one of the insulating layers may be made of a metal oxide and/or a metal nitrile, with the other being made of a resin.

A moistureproof layer (gas barrier layer) maybe provided on one or both sides of the substrate. The moistureproof layer is preferably made of an inorganic substance, such as silicon nitride or silicon nitride. The moistureproof layer of such material can be formed by high frequency sputtering or like techniques. If desired, the substrate may further have a hard coat layer, an undercoat layer, etc. formed thereon.

In order to prevent moisture and/or oxygen permeation into the OLED thereby to secure durability of the diode, it is desirable for the substrate to have a moisture permeability (water vapor transmission rate) of 0.1 g/m²·day or less, preferably 0.05 g/m²·day or less; still preferably 0.01 g/m²·day or less, and an oxygen permeability (gas transmission rate) of 0.1 ml/m²·day·atm or less, preferably 0.05 ml/m²·day·atom or less, still preferably 0.01 ml/m²·day·atm or less. The moisture permeability is measured in accordance with JIS K7129 B method (Mocon method), and the oxygen permeability is measured in accordance with JIS K 7126 B method (Mocon method).

(3) Electrodes

(a) Transparent Electrode

The transparent electrode usually serves as an anode supplying positive holes to a light emitting layer, etc. The shape, structure, size, and the like are selected appropriately according to the use of the diode. The transparent electrode may be designed to serve as a cathode, in which case the back electrode is designed to function as an anode.

Materials making up the transparent electrode include metals, alloys, metal oxides, electrically conductive organic compounds, and mixtures thereof. Those having a work function of 4.0 eV or higher are preferred for use as an anode. Examples of useful anode materials are semiconductive metal oxides, such as tin oxide doped with antimony or fluorine (ATO or FTO), tin oxide, zinc oxide, indium oxide, indium tin oxide (ITO), and indium zinc oxide (IZO); metals, such as gold, silver, chromium, and nickel; mixtures or laminates of these metals and conductive metal oxides; electrically conductive inorganic substances, such as copper iodide and copper sulfide; electrically conductive organic substances, such as polyaniline, polythiophene, and polypyrrole; and laminates of these materials and ITO.

The transparent electrode is formed on the substrate by an appropriate technique selected according to the material from, for example, wet film formation processes including printing and wet coating, physical processes including vacuum deposition, sputtering, and ion plating, and chemical processes including CVD and plasma-enhanced CVX. For instance, an ITO electrode is formed by direct current or radio frequency sputtering, vacuum deposition or ion plating. Where an organic conductive compound is chosen as a transparent electrode material, the electrode is formed by wet film formation.

The position where the transparent electrode is formed is not particularly limited and determined according to the intended use and purpose of the diode. The transparent electrode is generally formed on the substrate. In this case, the transparent electrode may be provided on either part of or the whole of a side of the substrate.

Patterning of the transparent electrode is carried out by chemical etching by photolithography, physical etching by laser machining, or vacuum deposition or sputtering through a mask by a lift-off or printing technique.

The thickness of the transparent electrode is decided appropriately according to the material and usually ranges from 10 nm to 50 μm, preferably 50 nm to 20 μm. To control heat generation and improve stability and durability of the diode, the transparent electrode preferably has a surface resistivity of 10³ Ω/square or less, still preferably 10² Ω/square or less.

The transparent electrode may be either colorless or colored but preferably has a transmittance of 60% or higher, particularly 70% or higher, to guarantee high light extraction efficiency. The transmittance is measured in a known manner with a spectrophotometer.

Details of a transparent electrode are described in Sawada Yutaka (ed.), Tomei Denkyokumaku no Shin-tenkai, CMC (1999), which can be applied to the present invention. Where a plastic substrate with low heat resistance is used, an ITO or IZO electrode formed at or below 150° C. is recommended.

b) Back Electrode

The back electrode usually serves as a cathode supplying electrons to a light emitting layer, etc. The shape, structure, size, etc. of the back electrode are not particularly limited and selected from among known electrodes according to the use of the diode. The back electrode may be designed to serve as an anode, in which case the transparent electrode is designed to function as a cathode.

Materials making up the back electrode include metals, alloys, metal oxides, electrically conductive organic compounds, and mixtures thereof. Those having a work function of 4.5 eV or less are preferred for raking a cathode. Examples of useful materials are alkali metals (e.g., Li, Na, and K), alkaline earth metals (e.g., Mg and Ca), gold, silver, lead, aluminum, sodium-potassium alloys, lithium-aluminum alloys, magnesium-silver alloys, rare earth metals (e.g., indium and ytterbium), and electrically conductive organic compounds such as polythiophene, polypyrrole, and poly-p-phenylene vinylene or ion-doped compounds thereof. These materials are preferably used as a combination of two or more thereof, while effective when used individually, for assuring both stability and electron injection capabilities.

Preferred of the recited materials are alkali metals and alkaline earth metals for their electron injection capabilities. Aluminum-based materials are particularly preferred for their storage stability. The term “aluminum-based materials” includes aluminum and an alloy or mixture of aluminum with 0.01 to 10% by weight of an alkali metal or an alkaline earth metal, e.g., a lithium-aluminum alloy or a magnesium-aluminum alloy. For the details of back electrode materials reference can be made in JP-A-2-15595 and JP-A-5-121172.

The back electrode can be formed by any known method chosen according to the material from, for example, wet film formation by printing or coating; physical film formation including vacuum deposition, sputtering, and ion plating; and chemical film formation including CVD and plasma-enhanced CVD. For example, a metal or like back electrode can be formed by sputtering a metallic material or materials. In using two or more materials, they may be sputtered either simultaneously or sequentially. Patterning of the back electrode is carried out by chemical etching by photolithography, physical etching by laser machining, or vacuum deposition or sputtering through a mask by a lift-off or printing technique.

While the position of the back electrode in the diode is not particularly limited and is selected appropriately according to the use of the diode, the back electrode is preferably formed on an organic layer. It is formed on either the entire area or a part of the organic layer. It is preferred to provide a dielectric layer of, for example, an alkali metal fluoride or an alkaline earth metal fluoride to a thickness of 0.1 to 5 nm between the organic layer and the back electrode so as to improve electron injection capabilities. Such a dielectric layer can be formed by vacuum deposition, sputtering, ion plating, etc.

The thickness of the back electrode is decided appropriately according to the material and usually ranges from 10 nm to 5 μm, preferably 50 nm to 1 μm. The back electrode may be either transparent or opaque. A transparent back electrode can be formed by forming a film as thin as 1 to 10 nm of the above recited material and laminating the thin film with a transparent conductive material such as ITO or IZO.

(4) Other Layers

The OLED preferably has a protective layer or a sealing layer for preventing deterioration of the luminescence performance.

(a) Protective Layer

Useful protective layers are described in JP-A-7-85974, JP-A-7-192866, JP-A-8-22891, JP-A-10-275682, and JP-A-10-106746.

The protective layer is provided as a top layer of the OLED. Where the diode has a transparent electrode, organic layers, and a back electrode on a substrate in the order described, the term “top layer” as used herein means an outermost layer provided on the back electrode. Where the diode has a back electrode, organic layers, and a transparent electrode on a substrate in this order, the term “top layer” means an outermost layer provided on the transparent electrode.

The protective layer is not particularly limited in material, shape, size, and thickness. Any material that prevents substances which would deteriorate the diode, such as moisture and oxygen, from entering the diode can be used. Such materials typically include silicon monoxide, silicon dioxide, germanium monoxide, and germanium dioxide. Methods for forming the protective layer include, but are not limited to, vacuum evaporation, sputtering, reactive sputtering, molecular beam epitaxy, cluster ion beam-assisted deposition, ion plating, plasma polymerization, plasma-enhanced CVD, laser-assisted CVD, thermal CVD, and wet coating techniques.

(b) Sealing Layer

A sealing layer for preventing moisture or oxygen from entering the diode is preferably provided. Materials of the sealing layer include tetrafluoroethylene copolymers, fluorine-containing copolymers having a cyclic structure in the main chain thereof, polyethylene, polymethylmethacrylate, polyimide, polyurea, polytetrafluoroethylene, polychlorotrifluoroethylene, polydichlorodifluoroethylene, chlorotrifluoroethylene copolymers, dichlorodifluoroethylene copolymers; water absorbing substances having a water absorption of at least 1%; moisture-proof substances having a water absorption of 0.1% or less; metals, e.g., In, Sn, Pb, Au, Cur Ag, Al, Ti, and Ni; metal oxides, eg., MgO, SiO, SiO₂, Al₂O₃, GeO, NiO, CaO, BaO, Fe₂O₃, Y₂O₃, and TiO₂; metal fluorides, e.g., MgF₂, LiF, AlF₃, and CaF₂; liquid fluorocarbons, e.g., perfluoroalkanes, perfluoroamines, and perfluoroethers; and liquid fluorocarbons having dispersed therein a moisture- or oxygen-adsorbent.

For the purpose of shielding the OLED from outside moisture or oxygen, the organic layers can be sealed with a sealing member, such as a seal plate or a seal container. The sealing member is not limited in shape, size, thickness, etc. as long as the organic layers can be sealed against outside air. The sealing member may be disposed only on the back electrode side, or the whole laminate containing the organic layers may be covered with the sealing member. Materials of the sealing member include glass, stainless steel, metals (eg. aluminum), resins (e.g., polychlorotrifluoroethylene, polyester, and polycarbonate), and ceramics.

If necessary, a sealant (adhesive) can be used to dispose the sealing member on the laminate. Where the whole laminate is covered with a sealing member, separate sealing member pieces may be bonded together by fusion without using a sealant. Useful sealants include ultraviolet curing resins, heat curing resins, and two-pack type curing resins.

The space between a sealing container and the OLED may be filled with a moisture absorbent or an inert liquid. Useful moisture absorbents include, but are not limited to, barium oxide, sodium oxide, potassium oxide, calcium oxide, sodium sulfate, calcium sulfate, magnesium sulfate, phosphorus pentoxide, calcium chloride, magnesium chloride, copper chloride, cesium fluoride, niobium fluoride, calcium bromide, vanadium bromide, molecular sieve, zeoite, and magnesium oxide. Useful inert liquids include paraffins, liquid paraffins, fluorine-containing solvents (e.g., perfluoroalkanes, perfluoroamines, and perfluoroethers), chlorine-containing solvents, and silicone oils.

(5) Driving of OLED

The OLED of the invention emits light on applying a direct current voltage (which may contain an alternating component, if needed) usually of 2 to 40 V between the anode and the cathode. For driving the OLED, the methods taught in JP-A-2-148687, JP-A-6-301355, JP-A-5-29080, JP-A-7-134558, JP-A-8-234685, JP-A-8-241047, U.S. Pat. Nos. 5,828,429 and 6,023,308, and Japanese Patent 2794615 can be utilized.

### EXAMPLES

The present invention will now be illustrated in greater detail with reference to Examples, but it should be understood that the present invention is not deemed to be limited thereto. Unless otherwise noted, all the parts and percents are by weight.

### Example 1

1) Preparation of Monochromatic Film

A 6 μm thick polyethylene terephthalate carrier film was coated with each of RBG inks (luminescent materials) having the following compositions with a die coater. The ink was applied to a width of 1 m at a rate of 20 m/min and dried to prepare a set of three monochromatic films. The dry thickness of the thus formed light emitting layer was 10 nm for every color.

Ink Composition for Red Light Emitting Layer:

| | | |
|---|---|---|
| BTIrQ (bis(2-phenylbenzothiazole)iridium | 1 | part |
| 8-hydroxyquinolate) | | |
| PVK (N-vinylcarbazole) | 40 | parts |
| PBD | 12 | parts |
| (2-(4′-t-butylphenyl)-5-(4″-(phenyl)phenyl)-1,3,4-ox | | |
| adiazole) | | |
| 1,2-Dichloroethane | 3200 | parts |

Ink Composition for Green Light Emitting Layer:

| | | |
|---|---|---|
| Ix (ppy)₃ | 1 | part |
| PVK | 40 | parts |
| PBD | 12 | parts |
| 1,2-Dichloroethane | 3200 | parts |

Ink Composition for Blue Light Emitting Layer:

| | | |
|---|---|---|
| Pt(ppy)₂Br₂ | 1 | part |
| PVK | 40 | parts |
| 1,2-Dichloroethane | 3200 | parts |

BTIrQ

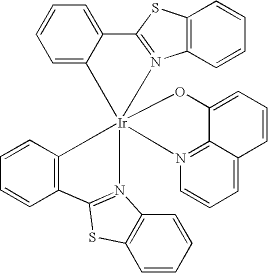

PVK

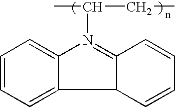

PBT

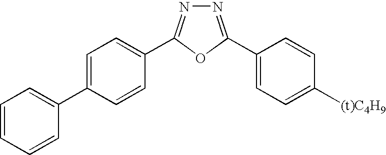

Ir(ppy)₃

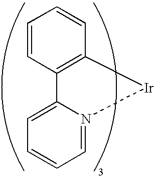

Pt(ppy)₂Br₂

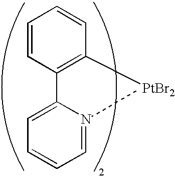

2) Preparation of Laminate A

A 50 μm thick polyimide film (UPILEX-50S, available from Ube Industries, Ltd.) was cleaned with isopropyl alcohol and subjected to oxygen plasma treatment. Aluminum was deposited on the plasma treated side of the film under a reduced pressure of about 0.1 mPa to form an electrode having a thickness of 0.2 μm. Lithium fluoride was then vacuum deposited on the Al electrode (in the same pattern of the Al electrode) to form a dielectric layer having a thickness of 3 nm. An aluminum lead was connected to the aluminum electrode to form an electrode structure.

An electron transporting compound shown below was vacuum deposited on the LiF layer under a reduced pressure of about 0.1 mPa to form an electron transporting layer having a thickness of 60 nm.

Electron Transporting Compound:

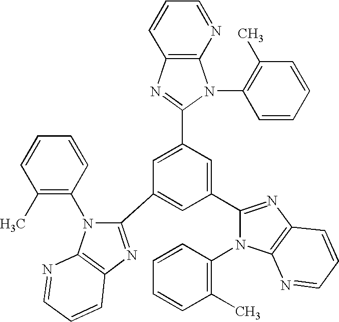

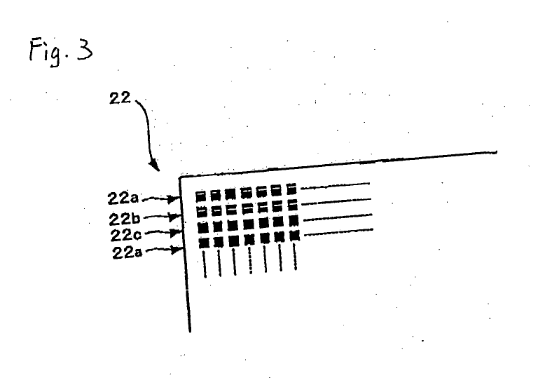

The three light emitting layers of the monochromatic films (transfer materials) were patternwise transferred successively to the electron transporting layer according to the procedure shown in FIG. 2 to form a matrix pattern made up of RBG pixels 22a, 22b, and 22c as shown in FIG. 3. The pixel size was 100 μm×100 μm for each color, and the distance between pixels was 50 μm. There was thus obtained a laminate A with a color pattern.

The patternwise transfer was carried out with pressing means in combination with heating means. An engraved roll having a prescribed pattern of projections on its peripheral surface was used as a pressing member 30 in combination with a back-up roll to perform patterning in a continuous manner. It is also possible to carry out patternwise transfer in a batch system by using, for example, a flat engraved plate in place of the engraved roll.

3) Preparation of Transparent Laminate B

A 0.7 mm thick glass plate was set in a vacuum chamber of a DC magnetron sputtering system, and an ITO target (indium:tin=95:5 by mole) containing 10% SnO₂ was sputtered under conditions of a substrate temperature of 250° C. and an oxygen pressure of 1×10⁻³ Pa to form a transparent ITO electrode having a thickness of 0.2 μm, The ITO thin film had a surface resistivity of 10 Ω/square. An aluminum lead was connected to the ITO transparent electrode.

The glass substrate with the ITO electrode was cleaned with isopropyl alcohol and subjected to oxygen plasma treatment. An aqueous dispersion of polyethylenedioxythiophene doped with polystyrene (PEDOT-PSS) (Baytron P®, available from Bayer AG) was applied to the plasma treated ITO electrode by spin coating at 2000 rpm for 60 seconds and dried at 100° C. in vacuo for 1 hour to form a 100 nm thick hole transporting layer. The transparent substrate with the ITO electrode and the hole transporting layer is designated laminate B.

PEDOT-PSS:

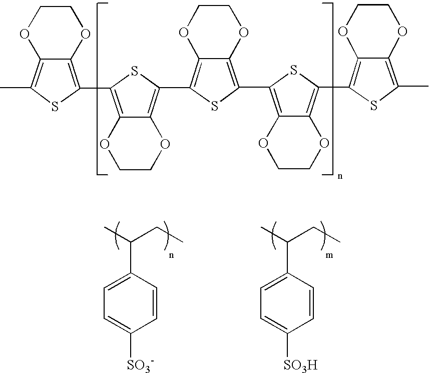

4) Preparation of Multi-Color OLED

The laminates A and B were superposed with their organic layer sides facing each other and bonded together by passing through a pair of hot rolls at 160° C., 0.3 MPa, and 0.05 m/min to prepare a multi-color OLED.

### Examples 2 to 5 and Comparative Examples 1 to 4

Multi-color OLEDs were prepared in the same manner as in Example 1, except for changing the thickness of the light emitting layer and the electron transporting layer at shown in Table 1 below.

5) Evaluation

The luminescence efficiency (lm/W) of the resulting OLEDs was measured with a spectroradiometer SR-3, supplied by Topcon. The results obtained are shown in Table 1.

TABLE 1

| | Thickness of | | |
|---|---|---|---|
| | Electron | Thickness of | Luminescence |
| | Transporting | Light Emitting | Effciency |
| | Layer (nm) | Layer (nm) | (lm/W) |
| Comp. Example 1 | 50 | 10 | 2.1 |
| Example 1 | 60 | 10 | 3.2 |
| Example 2 | 70 | 10 | 4.1 |
| Example 3 | 80 | 10 | 3.3 |
| Comp. Example 2 | 90 | 10 | 2.4 |
| Comp. Example 3 | 50 | 20 | 2.7 |
| Example 4 | 60 | 20 | 3.6 |
| Example 5 | 70 | 20 | 3.5 |
| Comp. Example 4 | 80 | 20 | 2.8 |

It is seen from Table 1 that the OLEDs according to the present invention achieve high luminescence efficiency.

According to the present invention, a light extraction efficiency of an OLED can be improved by optimizing the thickness of an electron transporting layer and a light emitting layer.

This application is based on Japanese Patent application JP 2003-47544, filed Feb. 25, 2003, the entire content of which is hereby incorporated by reference, the same as if set forth at length.

What is claimed is:

1. An organic light emitting diode comprising:
a substrate;
a transparent electrode;
at least two organic layers including a light emitting layer and an electron transporting layer; and
a back electrode,
wherein a thickness of the electron transporting layer is 60 nm or greater, and a total thickness of the electron transporting layer and the light emitting layer is 90 nm or smaller.

2. The organic light emitting diode according to claim 1, wherein the transparent electrode has a thickness of 50 to 210 nm.

3. The organic light emitting diode according to claim 1, wherein the transparent electrode has a thickness of 160 to 200 nm.

4. The organic light emitting diode according to claim 1, wherein a total thickness of the at least two organic layers is 90 to 300 nm.

5. The organic light emitting diode according to claim 2, wherein a total thickness of the at least two organic layers is 90 to 300 nm.

6. The organic light emitting diode according to claim 1, wherein a total thickness of the at least two organic layers is 150 to 250 nm.

7. The organic light emitting diode according to claim 1, wherein a total thickness of the transparent electrode and the at least two organic layers is 250 to 400 nm.

8. The organic light emitting diode according to claim 1, wherein a total thickness of the transparent electrode and the at least two organic layers is 300 to 350 nm.

9. The organic light emitting diode according to claim 1, wherein the thickness of the electron transporting layer is 70 to 80 nm.

10. The organic light emitting diode according to claim 1, wherein the total thickness of the electron transporting layer and the light emitting layer is 80 to 90 nm.

11. The organic light emitting diode according to claim 1, wherein a thickness of the light emitting layer is 10 to 20 nm.

12. The organic light emitting diode according to claim 1, which has at least two light emitting layers different in luminescence waveform in a side-by-side configuration.

13. The organic light emitting diode according to claim 2, which has at least two light emitting layers different in luminescence waveform in a side-by-side configuration.
